(19) United States
(12) Patent Application Publication
(10) Pub. No.: US 2008/0126262 A1
(43) Pub. Date: May 29, 2008

(54) System and Method for Secure Transactions

(76) Inventors: Colin Brady, San Jose, CA (US); Govinda Rajan, Huizen (NL)

Correspondence Address: PATTERSON & SHERIDAN, LLP/;LUCENT TECHNOLOGIES, INC, 595 SHREWSBURY AVENUE, SHREWSBURY, NJ, 07702, US

(21) Appl. No.: 11/564,408

(22) Filed: Nov. 29, 2006

(51) Int. Cl. H04L 9/00

(52) U.S. Cl. 705/75

(57) ABSTRACT

A system and method for conducting secure transactions are disclosed. The system includes a transaction card having a self-programming region for periodic update of a verification code, a server used for authenticating the card, and a network for transmitting data between the transaction card and the server. The method includes transmitting a current verification code and a current timestamp from the card to a transaction clearinghouse. Authentication of the transaction card is done by comparing the current verification code received and a reference verification code generated by the server, and a decision is made by the clearinghouse whether to approve the transaction.

### CROSS-REFERENCE TO RELATED APPLICATIONS

This application contains subject matter related to commonly owned U.S. patent application, Ser. No. ______, entitled “Self-programming Transaction Card”, (Attorney docket number Brady 2-11 (LCNT/128672)), filed concurrently herewith, which is herein incorporated by reference in its entirety.

### BACKGROUND OF THE INVENTION

1. Field of the Invention

The invention relates generally to a system and method for secure transactions, and more specifically, to a system and method using a transaction card with self-programming capability for periodic update of stored data.

2. Description of Related Art

Each year the world conducts over four trillion dollars in payment card transactions. For every hundred dollars spent six cents is lost to fraud, resulting in over two billion dollars in illegal charges that must be covered by banks and merchants each year. Attempts made to modernize and secure the credit network have largely failed, as they required upgrades to the payment card terminal network. As the installed base of terminals represents a $10 billion investment in the US alone, it is likely to be some time before a definitive answer to the magnetic strip terminal is widely adopted by the industry.

Although there are various measures used for ensuring payment card security, each approach has its own limitations. For example, smart cards, which require personal identification number (PIN) codes to validate transactions, are able to address only a small fraction of problems in fraudulent transactions, and also requires extensive upgrade from other existing card terminals.

The use of a card validation code is helpful with transactions in which the card is not physically present, such as those conducted over telephones or on the internet. However, once the card validation code is known by others, security is easily compromised not only because of potential fraudulent use over telephone or internet, but also because of counterfeit card.

Other security measures involving more sophisticated technologies are also available, but they may be difficult to integrate with the legacy magnetic strip reader network, or otherwise require costly network upgrades. Therefore, there is an ongoing need for alternatives in improved security measures, especially ones that are readily compatible with existing devices and network.

### SUMMARY OF THE INVENTION

Various problems associated with the prior art are addressed by the present invention of a system and method for conducting transactions using a transaction card in which certain security data are periodically updated. One embodiment provides a system that includes a transaction card having a self-programming region configured for periodic update of a verification code, a server having a means for authenticating a transaction based on the periodically updated verification code, and a network for transmitting data between the card and the server.

Another embodiment provides a method that includes initiating a transaction request by presenting a transaction card having a current verification code, the current verification code being updated by a self-programming region of the transaction card at predetermined times, transmitting a card identification number and the current verification code to a transaction clearinghouse, comparing the current verification code received by the clearinghouse with a reference verification code generated for the transaction card by a server at the clearinghouse, and deciding whether to approve the transaction request based on whether a match exists between the current verification code and the reference verification code.

### BRIEF DESCRIPTION OF THE DRAWINGS

The teachings of the present invention can be readily understood by considering the following detailed description in conjunction with the accompanying drawings, in which:

FIG. 1 depicts a back view of a conventional payment or transaction card with a magnetic stripe;

FIGS. 2A-2B depict a front view and a back view, respectively, of a transaction card according to one embodiment of the present invention;

FIG. 3 depicts an electromagnetic coil connected to a power source for implementing one embodiment of the present invention;

FIG. 4A depicts the alignment of magnetic dipoles or magnetic elements on a magnetic stripe;

FIG. 4B depicts current signals from a read head corresponding to the encoded information of FIG. 4A;

FIG. 5A depicts an embodiment in which an even number of dipoles are arranged in the same direction to create a “1” data bit;

FIG. 5B depicts the encoding of a “0” bit by an even number of dipoles;

FIG. 6 depicts the output signal of a card reader as a function of time or location at the self-programming region of the transaction card of the present invention;

FIG. 7 depicts a system for conducting secure transactions using the self-programming transaction card of the present invention; and

FIG. 8 depicts a method of conducting a transaction according to one embodiment of the present invention.

To facilitate understanding, identical reference numerals have been used, where possible, to designate identical elements that are common to the figures.

### DETAILED DESCRIPTION

The invention provides a system and method for secure transactions and, more specifically, for improved authentication of card-based transactions. The system includes a transaction card with a processor and a self-programming region for periodic update of a security code, a server for authenticating the security code, and a network for transmitting data between the transaction card and the server.

The transaction card of the present invention has a self-programming region that allows periodic update of security data using components provided on the card. The self-programming region contains one or more self-programming components, each of which can be switched between two states depending on the direction of an electrical current through the component. The self-programming components are used for updating a security code or card verification code (CVC) at various time intervals, e.g., as predetermined by an algorithm in a microprocessor on the card. A transaction can be validated only if the card is presented at the point of use, and if the time-dependent verification code matches that of a remote server belonging to the card issuer. The use of the dynamic or time-dependent code provides added security against counterfeit cards or other fraudulent uses associated with a conventional card. Another advantage of this transaction card is the backward compatibility with legacy magnetic stripe technology, which makes the card desirable for a variety of security applications, including building security.

In one embodiment, the self-programming region is operatively coupled to the magnetic stripe, and electromagnetic coils are used to encode data bits on the magnetic stripe. In another embodiment, the electromagnetic coils serve as a magnetic stripe emulator by generating magnetic fields that can be read by magnetic stripe card readers. In yet another embodiment, the self-programming components are one or more magnetic random access memory (MRAM) elements for storing the periodically updated code.

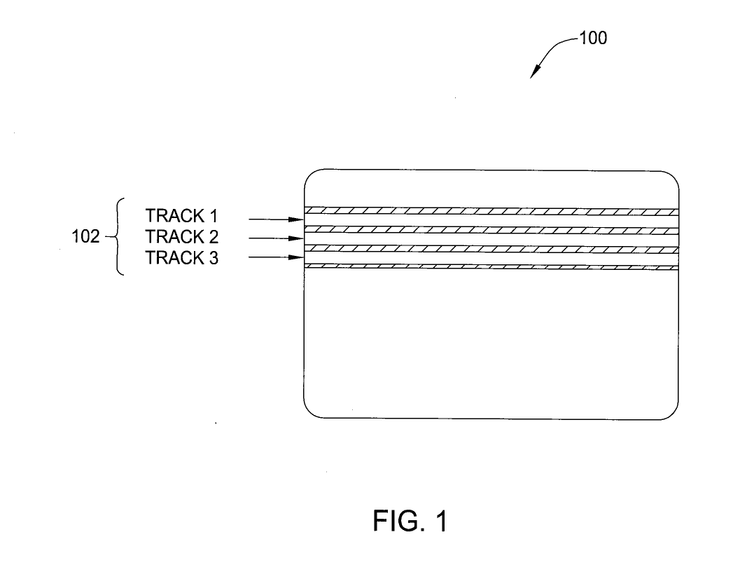

FIG. 1 is a schematic illustration of a back view of a conventional payment or transaction card 100 with a magnetic stripe 102. The magnetic stripe 102 usually contains three tracks, each being 0.110 inches (2.79 mm) wide. There are various standards defining different aspects of a transaction card, including the physical properties as well as information storage. For example, under the ISO/IEC 7811 standards, Tracks 1 and 3 are recorded at 210 bits per inch (8.27 bits/mm) and Track 2 has a bit density of 75 bits per inch (2.95 bits/mm). Each track can either contain 7-bit alphanumeric characters, or 5-bit numeric characters. Both Track 1 and Track 2 are read-only tracks, and contain information such as card holder's name, card number, expiration date, among others. Track 3 is a read/write track that is not frequently used.

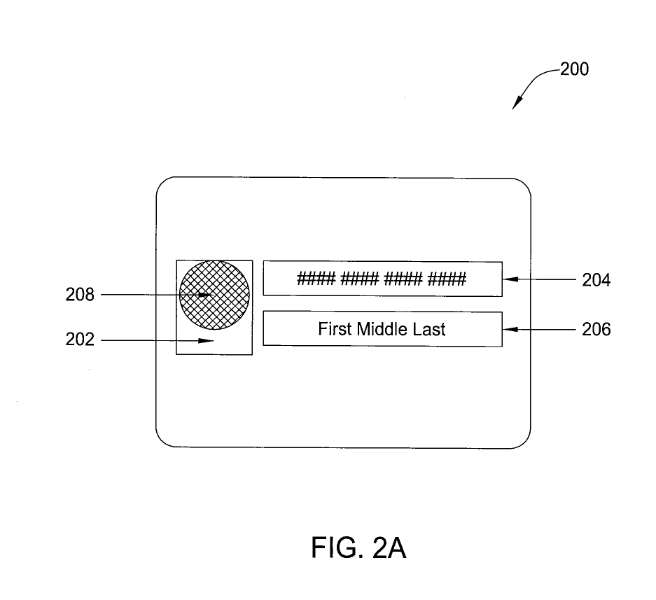

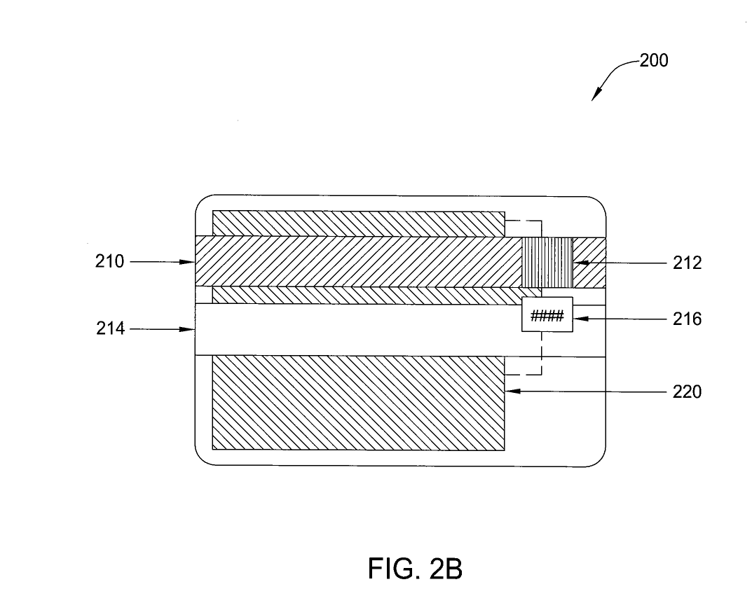

FIGS. 2A-2B are schematic illustrations of a front view and a back view, respectively, of a transaction card 200 according to one embodiment of the present invention. As shown in the front view of FIG. 2A, the card 200 has a processor 202, in addition to a card number region 204 and a card holder name region 206. The processor 202 contains a time stamp for the current time information and a memory with an algorithm for computing the verification code at certain predetermined time intervals. The algorithm may be a pseudo-random number generator, and may also contain the current time as a parameter in the algorithm for computing the verification code. Alternatively, a separate memory containing the algorithm may be provided on the card 200 for access by the processor 202. An optional smart card interface 208 is also provided.

FIG. 2B shows the backside of the card 200 comprising a magnetic stripe 210, a power source 220, and a self-programming region 212. The self-programming region 212 is connected to the power source 220, which is also connected to the embedded processor 202. The power source 220 provides power necessary for computing the card verification code and for updating the code on the self-programming region 212. In one embodiment, the power source 220 is a flexible thin battery. Long-life, flexible batteries are commercially available from a variety of manufacturers, e.g., Thin Battery Technologies, Inc., Power Paper, NEC and Solicore, among others. A signature region 214 and an optional digital display 216 are also provided. The digital display 216, if present, is also connected to the self-programming region 212 and the power source 220.

In one embodiment, the self-programming region 212 comprises a part of the magnetic stripe 210 and the encoding is done in accordance with existing standards on Track 1 or Track 2. This allows compatibility with existing card readers, such as legacy readers. For applications where compatibility is not required, the self-programming region 212 may be provided on Track 3, and can be encoded in a variety of suitable formats. A card verification code stored in the self-programming region 212 is periodically (or automatically) updated by components on the card 200 according to certain predetermined procedures.

The self-programming region 212 of the magnetic stripe 210 has one or more self-programming components. In one embodiment, one or more embedded electromagnetic coils are used to program the data bits on the magnetic stripe 210, with the security or verification code being stored on the magnetic stripe until the next update. In another embodiment, the electromagnet coils are used in a magnetic stripe emulator mode, in which the magnetic fields generated by the coils are used to represent the data bits. In this case, the coils can be provided in appropriate locations in Track 1 or Track 2 of the magnetic stripe 210 to allow for compatibility with card readers, although they are not necessarily coupled to the magnetic stripe 210, since the coils are not used to align the magnetic elements of the magnetic stripe 210.

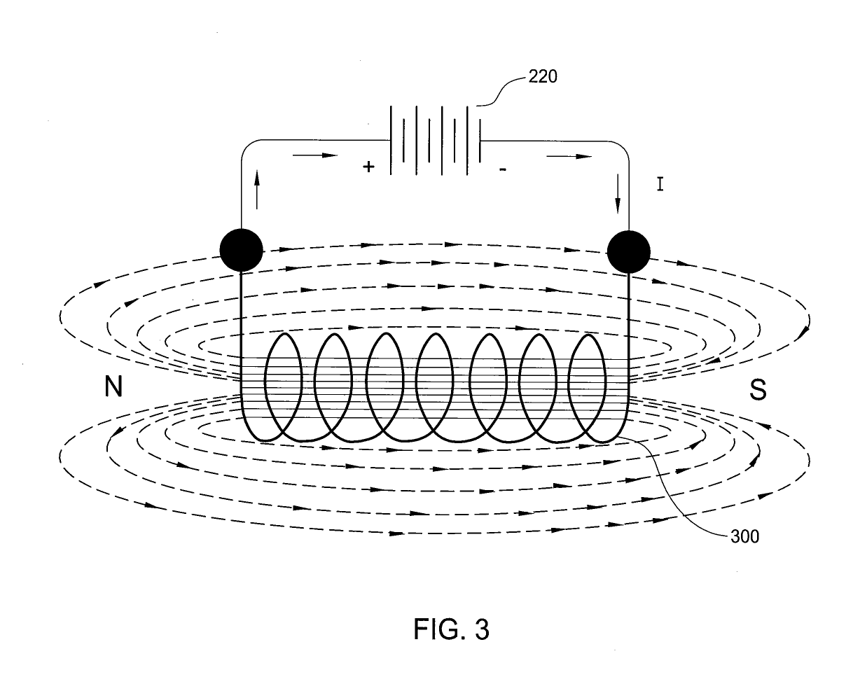

FIG. 3 shows an electromagnetic coil 300 connected to the power source 220. When an electrical current is provided by the power source 220 to the coil 300, a magnetic field is created in a direction perpendicular to the current flow in the coil 300. The N and S polarities of the resulting magnetic field is illustrated for the electron flow direction I. Magnetic particles, e.g., ferric oxide or other suitable materials, on the magnetic stripe under the influence of coil 300 will be aligned along the field direction. When the electrical current is passed through the coil 300 in the opposite direction, the resultant magnetic field direction is reversed, thus reversing the alignment of the magnetic particles on the magnetic stripe.

In one embodiment, the electromagnetic coil 300 may be a thin film magnetic inductor such as that described by Korenivski and van Dover, “Thin-Film Magnetic Inductors for Integrated Circuit Applications”, FP-12 Abstract, 7^{th} Joint MMM-Intermag Conference, 6-9 Jan., 1998. Other thin film magnetic inductor designs are also suitable, including for example, Wang et al., U.S. Pat. No. 6,822,548, “Magnetic Thin Film Inductors”, issued Nov. 23, 2004; and Zhuang et al., “Study of Magnetic On-chip Inductors”, Proc. SAFE 2001, Nov. 28-29, 2001, Veldhoven, the Netherlands, pp. 229-233. On the transaction card 200, the coils 300 are disposed in close proximity to the magnetic stripe material in the corresponding track of the self-programming region 212. In one embodiment, the coils are formed at locations on the track corresponding to the card verification code, with the magnetic stripe material being on the inside of the coils, i.e., forming the core. The fabrication of the coils 300 and integration with existing magnetic stripe can be done with techniques known to one skilled in the art and the dimensions and/or layout of each coil are designed to be compatible with encoding of typical magnetic stripe materials. The power source 220 and the coils 300 are designed to allow currents in two directions to be passed through each coil to generate a magnetic field sufficient for programming the data bits.

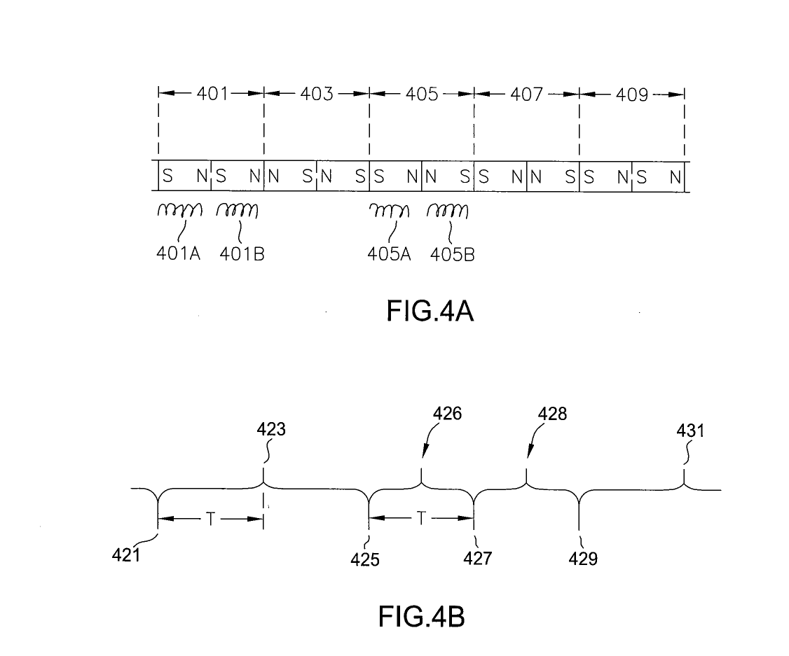

FIG. 4A illustrates schematically the alignment of magnetic dipoles or magnetic elements (each may correspond to one or more magnetic particles) on a magnetic stripe representing various data bits “1” and “0” according to a commonly used scheme F2F or Aiken BiPhase under the ISO/IEC 7811 standards. Each “0” and “1” bit has the same physical length, and each comprises two magnetic dipoles. For the “0” bit, the two dipoles within the bit are aligned in the same directions, while for the “1” bit, the two dipoles are aligned in opposite directions. For example, bits 401, 403 and 409 are “0” bits, each having their respective magnetic dipoles aligned in the same direction, i.e., S-N/S-N or N-S/N-S. Bits 405 and 407 are “1” bits, and their respective dipoles are aligned in opposite directions, e.g., S-N/N-S or N-S/S-N. According to one embodiment of the present invention, each dipole has an associated electromagnetic coil that is configured for passing a current through the dipole in two possible directions for aligning the dipole in either N-S or S-N orientation. The dipoles for bits 401 and 405 are illustrated respectively as 401A, 401B and 405A, 405B in FIG. 4A (others are omitted for the sake of clarity). The length of each coil 300 is designed to be similar to the typical physical length of a bit on existing Track 1 or Track 2. Adjacent coils can be arranged in close proximity to one another, e.g., abutting each other. Alternatively, each adjacent coil can also be spaced apart by a certain distance, if desired, with the distance being dependent on the magnetic field strength produced by the maximum current through the coils.

Under the F2F scheme, adjacent bits are always arranged to have the same polarity (N or S) abutting each other, resulting in a region of large concentration of magnetic flux lines between two bits. To initiate a read operation, the transaction card 200 is swiped through a card reader. The high flux regions of the magnetic stripe will induce a current in the read head, with opposite polarities of the flux lines resulting in currents in opposite directions. This is illustrated in FIG. 4B, which shows the current signals from the read head corresponding to the encoded information of FIG. 4A. The data bits are decoded based on the flux changes detected within each bit length or the elapsed time between flux transitions. Thus, a bit “0” is detected if the separation of adjacent flux transitions occur close to a bit period T, e.g., signals 421 and 423 for bit 401, 423 and 425 for bit 403, and signal 429 and 431 for bit 409. For data bit “1”, there is an additional flux transition occurring in the middle of its bit length or near half a bit period, e.g., signal 426 around the middle of the period for bit 405, with signals 425 and 427 marking the beginning and the end of the bit 205. Clocking bits such as a string of “0” bits are also provided at the beginning and the end of a track for determining the bit period. Since most manual card swipes are done at a relatively constant speed, the bit period or bit length can be determined based on the signals generated from the clocking bits.

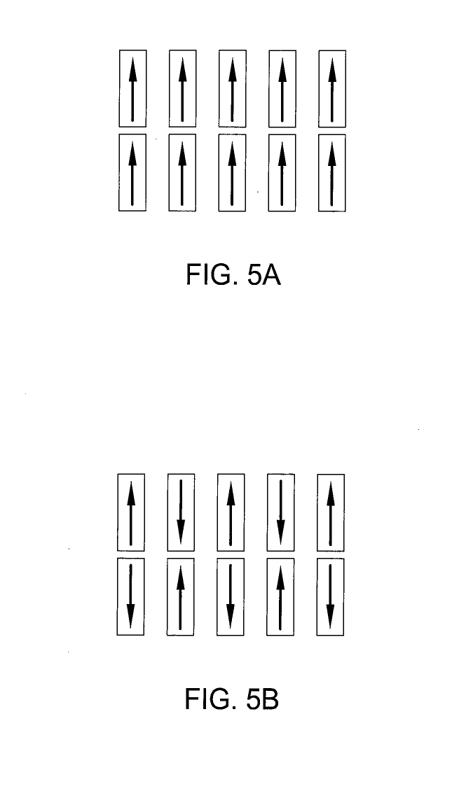

Aside from the scheme illustrated in FIG. 4A, other variations can also be used to encode the data bits, as long as the resultant magnetic field lines can be detected by the card reader for proper reading of the respective bits. For example, FIG. 5A illustrates an embodiment in which an even number of dipoles are arranged in the same direction to create a “1” data bit. FIG. 5B shows the encoding of a “0” bit by an even number of dipoles, arranged such that half of the dipoles are aligned in one direction and the other half aligned in the opposite direction, resulting in an overall cancellation of the magnetic field.

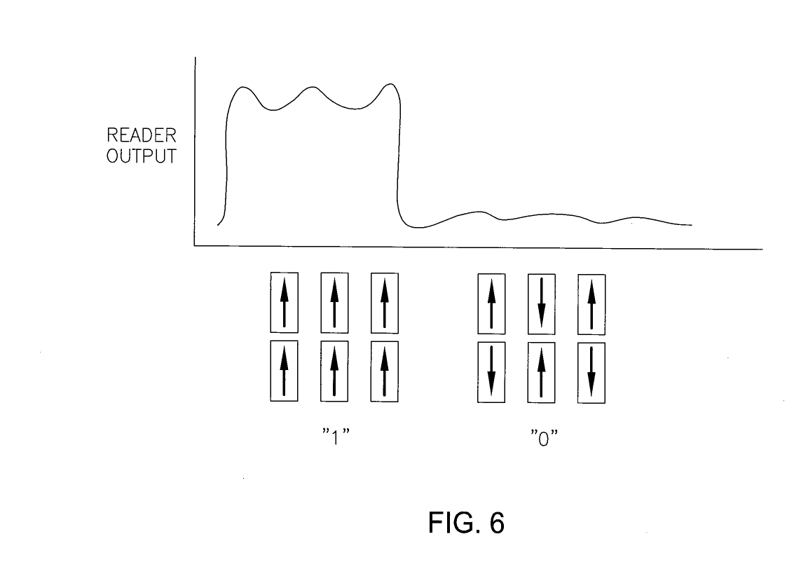

A card reader configured to integrate the magnetic fields from individual dipoles can read the data as either a “0” or a “1” depending on the overall magnetic field of the dipoles. FIG. 6 shows the output signal of a card reader as a function of time or location at the self-programming region 212 of a track, showing a “1” bit and a “0” bit stored in the self-programming region 212.

Alternatively, each bit can also be encoded by a single dipole, as long as the dipole provides sufficient magnetic field strength for detection by the card reader. For example, a “1” bit can be represented by the dipole being aligned in a first direction, and a “0” bit represented by the dipole being aligned in a second (or opposite) direction.

The transaction card 200 can be configured to initiate self-programming under different conditions. In one embodiment, the processor 202, based on an embedded algorithm, generates a new code at predetermined time intervals, and sends a control signal to the power source 220, which in turn provides current to the coils for updating the data bits for the security code in the self-programming region 212. The algorithm may be based on a pseudo-random number generator, and may include the current time as a parameter for computing the verification code. In one embodiment, a new code is generated about every 30 seconds. It is understood, however, that other time intervals can also be used, and that the self-programming may or may not be done at regular intervals (i.e., the time intervals between self-programming or update may also be variable).

Alternatively, instead of computing the verification code on a real-time basis using the algorithm on the processor 202, verification codes for a relatively long time period, e.g., on the order of a few years, can be generated by a server in advance of issuing the card to the user. In this embodiment, a list of the time-dependent verification codes (corresponding to predetermined time intervals) are stored in the memory of the card 200 for retrieval by the processor 202 at future times. It is also possible to provide for uploading these verification codes to the memory on the card 200 at specific secure card programming terminals, such as those available at banks or other authorized facilities.

The current verification code may be displayed on the optional digital display 216, which may be a variety of non-volatile, low resolution and low power consumption displays that are commercially available from different sources, e.g., elnk, Fujitsu and Phillips, among others. The display may be used, for example, by the card user for manually entering the current code to a transaction device for validation purpose, instead of having the magnetic stripe 210 read by a card reader.

The optional smart card interface 208 can be used for various functions, such as providing communication between the transaction card 200 and the card reader or other devices, providing an interface to an external power source, or for re-charging the power source 220 on the transaction card 200, among others.

The dynamically updated card verification code can be used in conjunction with existing security measures such as a personal identification number (PIN) for publicly authenticating transactions without jeopardizing the security of the card. For example, to conduct a transaction using the transaction card 200, a card holder will present the card 200 to a merchant for swiping at a card reader. The data on the card, including the dynamically generated card verification code (CVC), is communicated by the card reader to a card issuer's remote server, which validates the current CVC as well as other data. Unlike other data on the card, e.g., card number, card holder's name, expiration date, and so on, the dynamically updated CVC cannot be easily duplicated by unauthorized parties. Thus, the combined use of the CVC code and the PIN, which is not stored on the card and is known only by the card holder, provides an added level of security to the transactions compared to other existing security measures.

Since the card holder does not have control over the self-programming of the CVC, it is also possible that the card may be read as the CVC is being updated. This may lead to a discrepancy between the CVC on the card and the remote server, resulting in a validation failure. Thus, one embodiment of the invention provides for temporarily disabling the start and end bit patterns (e.g., clock bits) on the track before each self-programming step, and enabling these bits after the code update. If the card is read during CVC update, the disabled start and end bit patterns will cause a read error at the card reader (as opposed to a validation failure), in which case, the card can be swiped again soon afterwards when the start and end bit patterns are enabled.

In another embodiment, the coils 300 in the self-programming region 212 of the card 200 are configured to function as a magnetic stripe emulator, with the magnetic fields generated by the coils 300 being detected directly by a magnetic stripe card reader. In this emulator mode, the dynamic verification code is not stored on any tracks of the magnetic stripe 210. Thus, the self-programming region 212 does not have to be coupled to the magnetic stripe 210. Currents are provided from the battery 220 to the coils 300 on a continuous basis so that the data bits (represented by the magnetic fields of the coils 300) can be read by the card reader. Alternatively, in order to preserve the battery life in this emulator mode, a sensor may be provided on the card 200 to allow for manually activating the coils for generating the verification code. For example, an inductive sensor may be used to sense a touch by a finger for activating the generation of the verification code under the emulator mode.

In yet another embodiment, the self-programming component is a MRAM element, or more specifically, a magnetic tunnel junction element, which is a non-volatile memory whose data states “0” and “1” can be written by passing a current through the memory cell in opposite directions. In this embodiment, the magnetic tunnel junction elements function independently from the magnetic stripe, and can generally be located anywhere on the transaction card 200. The data stored by the MRAM elements can be read by an appropriate reader. Details regarding MRAM fabrication and technology can be found, for example, in Ditizio et al., “Cell Shape and Patterning Considerations for Magnetic Random Access Memory (MRAM) Fabrication”, Semiconductor Manufacturing Magazine, January 2004; and in Gallagher and Parkin, “Development of the magnetic tunnel junction MRAM at IBM: From first junctions to a 16-Mb MRAM demonstrator chip”, IBM J. Res. & Dev., vol. 50, No. 1, pg. 5-23A, January 2006, both of which are incorporated herein by reference in their entirety.

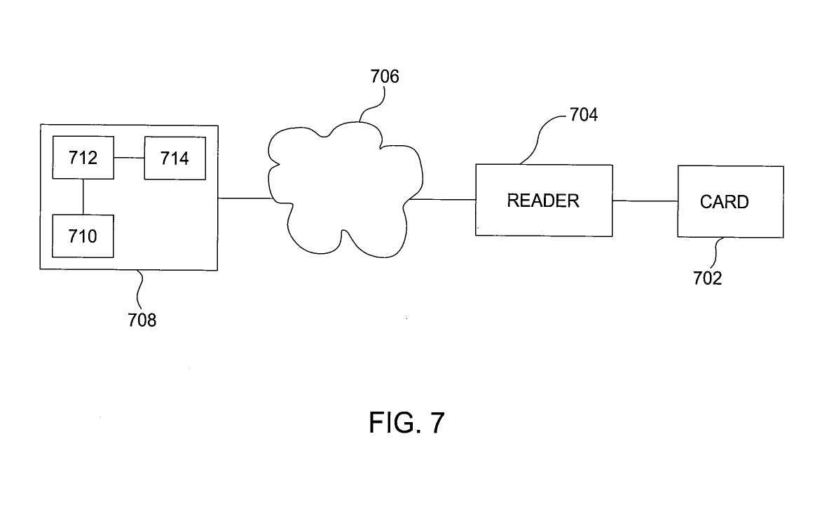

Secure transactions using the self-programming transaction card described above can be conducted in a system such as that illustrated in FIG. 7. Data on a transaction card 702, including the card number, the time of transaction, e.g., current timestamp of the card, and the current verification code, is accessed by a card reader 704. The card reader 704 may generally be any suitable readers or devices that are compatible with the data storage medium on the transaction card 702, e.g., a magnetic stripe reader. The card's data and other relevant data, e.g., relating to the merchant and the specific transaction, are transmitted by the card reader 704 via a suitable communications network 706 to a transaction clearinghouse 708. The communications network 706 may be a public or private network.

The transaction clearinghouse 708 is typically a remote facility with a server 710 and a central database 712 for authenticating payment card transactions. The central database 712 contains data for a list of transaction card numbers and at least a corresponding current verification code for each card. The verification code maintained at the clearinghouse 708 can be referred to as a reference verification code. Aside from using conventional methods for validating the transaction, the clearinghouse 708 compares the current verification code it received from the card reader 704 with the reference verification code from the central database 712. If the validation requirements based on conventional methods are met, and the verification code from the card reader 704 matches the reference verification code, then the transaction card 702 is authenticated, and the transaction clearinghouse 708 approves the transaction. Otherwise, the transaction is denied.

Different approaches can be used to provide the reference verification code to the central database 712. In one embodiment, the server 710 contains the same algorithm residing on the card 702. The server 710 computes, in advance, a number of reference verification codes corresponding to the predetermined times specified in the algorithm, and stores the data in the central database 712. When the transaction request is received, the server 710 retrieves the reference verification code according to the timestamp of the transaction for authentication purpose. In an alternative embodiment, the time stamp is not required to be transmitted by the card 702. Instead, the server 710 and the card 702 are synchronized in time such that the local time at the server location can be used to retrieve the proper reference verification code.

Alternatively, the reference verification code can be computed in real-time, e.g., when the transaction request is received, instead of storing the pre-calculated list of codes on the database 712. In yet another embodiment, a different server 714 connected to the database 712 may be used to compute the reference verification codes, and only the current reference codes for the transaction cards are sent to the database 712 on an ongoing or continuous basis. Using a different server 714 for computing the reference codes can help ease the load on server 710. Furthermore, by sending only the current (updated) reference codes to the database 712 (as opposed to computing a number of reference codes in advance), the storage capacity requirement for database 712 can be reduced. Depending on the process time requirements and resource considerations, many other variations for generating, storing and accessing reference verification code data at the clearinghouse can also be used.

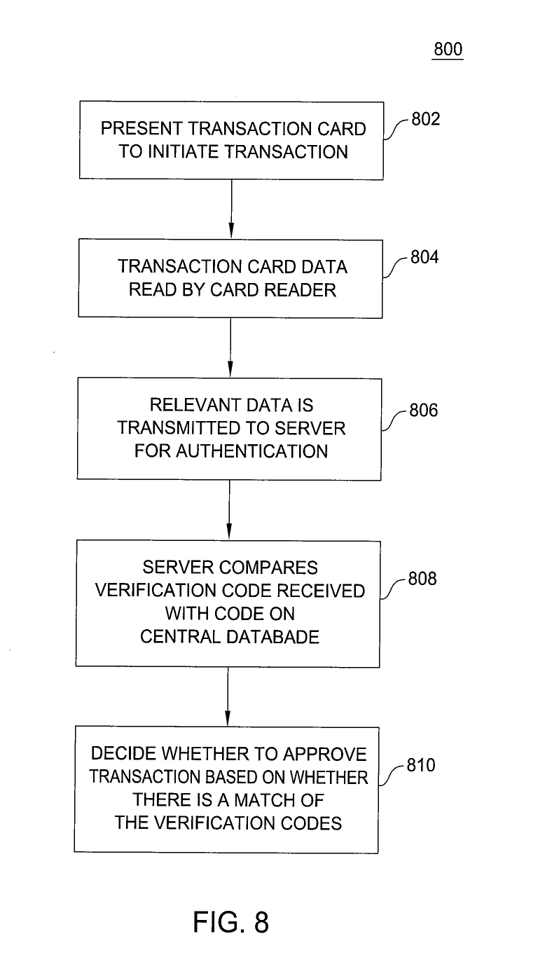

FIG. 8 illustrates one embodiment of a method 800 of conducting a transaction using the transaction card 702. In step 802, a self-programming transaction card is presented to initiate a transaction. In step 804, data on the transaction card, which includes, for example, the card identification number, the current verification code and the current time from the card, is read by a suitable card reader. In step 806, relevant data is transmitted by the card reader via a communications network to a remote server for authentication. In step 808, the server accesses a database to retrieve a reference verification code for the particular transaction card and compares with the current verification code received from the card reader. In step 810, a decision is made as to whether the transaction can be approved based on whether the verification code data from the card reader matches that on the database.

While the foregoing is directed to embodiments of the present invention, other and further embodiments of the invention may be devised without departing from the basic scope thereof, and the scope thereof is determined by the claims that follow.

1. A system for secure transactions, comprising:
a transaction card having a self-programming region configured for periodic update of a verification code;
a server comprising a means for authenticating a transaction based on the periodically updated verification code; and
a network for transmitting data between the card and the server;
wherein track bit patterns are disabled during the verification code update such that a card read during verification code update causes a read error and not a validation failure.

2. The system of claim 1, wherein the transaction card further comprises a processor coupled to a power source, the processor having an algorithm for computing the verification code at predetermined time intervals and communicating with the power source for updating the verification code in the self-programming region.

3. The system of claim 2, wherein the self-programming region comprises:
at least one self-programming component configured to receive an electrical current from the power source in two directions, the at least one self programming component having a first orientation associated with one current direction and a second orientation associated with the other current direction.

4. The system of claim 3, wherein the at least one self-programming component is one of an electromagnetic coil and a magnetic random access memory element.

5. The system of claim 2, wherein the transaction card further comprises a magnetic stripe and the self-programming region is operatively coupled to the magnetic stripe.

6. The system of claim 5, wherein the self-programming region comprises at least one electromagnetic coil for encoding the verification code on the magnetic stripe.

7. The system of claim 2, wherein the algorithm comprises a pseudo-random number generator.

8. The system of claim 4, wherein the at least one self-programming component is an electromagnetic coil configured to operate in a magnetic stripe emulator mode.

9. A method for conducting a transaction, comprising:
initiating a transaction request by presenting a transaction card having a current verification code, the current verification code being updated by a self-programming region of the transaction card at predetermined times;
transmitting a card identification number and the current verification code to a transaction clearinghouse;
comparing the current verification code received by the clearinghouse with a reference verification code generated for the transaction card by a server at the clearinghouse; and
deciding whether to approve the transaction request based on whether a match exists between the current verification code and the reference verification code;
wherein track bit patterns are disabled during the verification code update such that a card read during verification code update causes a read error and not a validation failure.

10. (canceled)

11. The method of 10, wherein the current verification code is computed by executing an algorithm residing on the transaction card and the algorithm comprises a pseudo-random number generator.

12. The method of 11, wherein the algorithm further comprises the current time as a parameter for computing the verification code.

13. The method of 11, wherein the reference verification code is generated by the server at the clearinghouse using a copy of the algorithm.

14. The method of 11, further comprising:
generating the reference verification code at the time of receiving the transaction request.

15. The method of 11, further comprising:
prior to receiving the transaction request, generating a plurality of the reference verification codes corresponding to the predetermined times;
storing the plurality of the reference verification codes in a database at the clearinghouse; and
retrieving the reference verification code corresponding to the current time.
